(19) United States
(12) Patent Application Publication
(10) Pub. No.: US 2003/0105861 A1
(43) Pub. Date: Jun. 5, 2003

(54) System and method for managing and displaying representative severity of network element in SNMP

(76) Inventor: Jong-Ky Lee, Suwon-shi (KR)

Correspondence Address: Robert E. Bushnell, Suite 300, 1522 K Street, N.W., Washington, DC, 20005, US

(21) Appl. No.: 10/307,303

(22) Filed: Dec. 2, 2002

(30) Foreign Application Priority Data
Dec. 4, 2001 (KR) 2001-76288

(51) Int. Cl. G06F 15/173

(52) U.S. Cl. 709/224

(57) ABSTRACT

The present invention relates to a method for managing a network element. In particular, in the present invention, simple network management protocol (SNMP) trap information generated from a network element which is managed on a network map by a simple network management protocol (SNMP) manager is analyzed and administrated, so that a representative alarm severity can be reflected from the administrated information to a network element symbol on the network map to render various means. To this end, a trap is received from the network element, and information regarding E (enterprise), G (generic) and S (specific) is fetched from received trap information. On the basis of the fetched information, a significance is determined depending upon an alarm connection configuration (alarm_conf) of each device, and a distinguish name (dn) is determined from a distinguish name (dn) configuration (dn_conf) of each device. If the determined significance refers to a significance related with release, alarm information stored in an alarm information configuration (alarm_info) is deleted. If the determined significance does not refer to release, new alarm information is stored in the alarm_info and is properly converted to be variously displayed by a user in conformity with a network element.

### CLAIM OF PRIORITY

This application makes reference to, incorporates the same herein, and claims all benefits accruing under 35 U.S.C. §119 from my application METHOD AND SYSTEM FOR DISPLAY AND MANAGEMENT THE REPRESENTATIVE SEVERITY OF NETWORK ELEMENT IN SNMP MANAGER filed with the Korean Industrial Property Office on 4 Dec. 2001 and there duly assigned Serial No. 2001-0076288.

### BACKGROUND OF THE INVENTION

1. Technical Field

The present invention relates to a method for managing a network element, and more particularly, relates to a system and a method which analyze simple network management protocol (SNMP) trap information generated from a network element and which provide representative severity of network elements.

2. Related Art

The simple network management protocol (SNMP) has drawn considerable attention as a communication network managing technique. The simple network management protocol (SNMP) was developed in the United States as a standard for managing the Internet, and has been adopted throughout the world as an actual standard technique like the transmission control protocol/Internet protocol (TCP/IP).

Generally, in a system adopting the simple network management protocol (SNMP), a management unit is called a manager, and management objects are called agents. A management information transmission network which connects the manager and the agents with each other is based on the transmission control protocol/Internet protocol (TCP/IP) scheme. Communication using the simple network management protocol (SNMP) is implemented between the manager and the agents by utilizing instructions such as management information search, management information continuous search, management information set, notification of exceptive operation, and the like, on the basis of a management information base (MIB).

Network maps of various simple network management protocols (SNMPs) provide corresponding symbols with respect to all network elements supporting the SNMPs. A user can perceive a severity of a network element when the network element is not operated, by viewing a symbol of the corresponding network element that is changed on the network map into a single color (such as red, for example). A variety of different urgency severities can exist, from a minimum severity such as “warning” up to a maximum severity such as “critical.”

Typically, such a network map is not designed to properly reflect this variety of different urgency severities and is not configured to be capable of developing a severity in accordance with each significance, and therefore such a network map does not satisfy the user. In other words, with such a network map, since it is impossible to grasp severities of the network on the network map, and since it is only possible to know whether or not the network element is functioning, a representative severity cannot be obtained depending upon a significance of each severity.

In addition, even in the case of employing an application programming interface (API) provided in the network map, in order to implement a processing task for a peculiar SNMP trap provided for each network element, a separate function must be provided for each network element.

It would be desirable to utilize a system and method for managing and displaying representative severity of network elements in a simple network management protocol (SNMP) manager. Efforts have been made to improve processes related to the simple network management protocol (SNMP) and other networking protocols.

Exemplars of recent efforts in the art include: “SNMP1˜3, RMON1˜2” compiled by William Stalling, Addison Wesley, 1996, pages 173˜190; Korean Patent Laid-open Publication No. 10-2001-27156; U.S. Pat. No. 6,044,468 to Osmond, entitled SECURE TRANSMISSION USING AN ORDINARILY INSECURE NETWORK COMMUNICATION PROTOCOL SUCH AS SAMP, issued on Mar. 28, 2000, U.S. Pat. No. 6,181,776 to Crossley et al., entitled NETWORK MANAGEMENT OF AUTOMATIC CALL DISTRIBUTOR RESOURCES, issued on Jan. 30, 2001, U.S. Pat. No. 6,182,157 to Schlener et al., entitled FLEXIBLE SNMP TRAP NECHANISM, issued on Jan. 30, 2001, U.S. Pat. No. 6,253,243 to Spencer, entitled AUTOMATED TRAP CONTROL FOR A DISTRIBUTED NETWORK MANAGEMENT SYSTEM, issued on Jun. 26, 2001, U.S. Pat. No. 6,366,926 to Pohlmann et al., entitled METHOD AND APPARATUS FOR THE DYNAMIC FILTERING AND ROUTING OF EVENTS, issued on Apr. 2, 2002, U.S. Pat. No. 6,404,743 to Meandzija, entitled ENHANCED SIMPLE NETWORK MANAGEMENT PROTOCOL (SNMP) FOR NETWORK AND SYSTEMS MANAGEMENT, issued on Jun. 11, 2002, U.S. Pat. No. 6,446,136 to Pohlmann et al., entitled SYSTEM AND METHOD FOR DYNAMIC CORRELATION OF EVENTS, issued on Sep. 3, 2002, U.S. Pat. No. 6,456,306 to Chin et al., entitled METHOD AND APPARATUS FOR DISPLAYING HEALTH STATUS OF NETWORK DEVICES, issued on Sep. 24, 2002, U.S. Pat. No. 6,425,006 to Chari et al., entitled ALERT CONFIGURATOR AND MANAGER, issued on Jul. 23, 2002, U.S. Pat. No. 6,430,613 to Brunet et al., entitled PROCESS AND SYSTEM FOR NETWORK AND SYSTEM MANAGEMENT, issued on Aug. 6, 2002, U.S. Pat. No. 5,802,146 to Dulman, entitled MAINTENANCE OPERATIONS CONSOLE FOR AN ADVANCED INTELLIGENT NETWORK, issued on Sep. 1, 1998, and U.S. Pat. No. 6,018,567 to Dulman, entitled MAINTENANCE OPERATIONS CONSOLE FOR AN ADVANCED INTELLIGENT NETWORK, issued on Jan. 25, 2000.

While these recent efforts provide advantages, I note that they fail to adequately provide a system and method for managing and displaying representative severity of network elements in a simple network management protocol (SNMP) manager.

### SUMMARY OF THE INVENTION

Therefore, the present invention has been made in view of the above problems, and it is an object of the present invention to provide a system and a method which modify a configuration of data to allow representative severities to be applied to all network elements supporting a simple network management protocol (SNMP), so that symbols of an SNMP manager can be rendered by various means on the basis of the modified configuration to let a user distinguish severity information and representative severity information of a corresponding network element can be rendered.

Another object of the present invention is to provide a method which can render corresponding information in connection with an alarm processor, thereby providing more powerful extended messaging system (EMS) and network management system (NMS) functions to a user.

In order to achieve the above objects and others, according to the present invention, there is provided a method for managing and displaying a representative severity of a network element in a simple network management protocol (SNMP) manager, comprising: a first step of receiving a packet data unit (PDU) of an SNMP trap from the network element to be managed in the SNMP manager and fetching factors capable of determining a significance; a second step of determining a significance from the trap packet data unit (PDU) fetched at the first step; a third step of finding a target to be released and deleting stored alarm input values when the significance determined at the second step refers to a significance related with release, and of storing a new alarm input value and notifying this to an alarm processor when the significance determined at the second step does not refer to a significance related with release; a fourth step of checking whether or not a sub network and a network element (NE) symbol are searched, searching the sub network and the network element (NE) symbol with a network map started when they are not searched, and receiving notification and a trap from alarm input when they are searched; a fifth step of obtaining a representative significance of the network element based on the notification and trap value received at the fourth step and converting the representative significance into a value for allowing various displays by a user; and a sixth step of variously displaying the value converted at the fifth step as a value representative of the network element.

In the present invention, a trap is received from a network element to be managed, and information regarding E (enterprise), G (generic) and S (specific) is fetched from the received trap information. On the basis of the fetched information, a significance is determined depending upon an alarm connection configuration (hereinafter, referred to as an “alarm_conf”) of each device, and a dn (distinguish name) is determined from a distinguish name configuration (hereinafter, referred to as a “dn_conf”) of each device. If the determined significance is related with release, alarm information stored in an alarm information configuration (hereinafter, referred to as an “alarm_info”) is deleted. If the determined significance is not related with release, new alarm information is stored in the alarm_info using the distinguish name (dn), and the significance is converted into a value allowing various displays by a user, to be applied to the network element.

To achieve these and other objects in accordance with the principles of the present invention, as embodied and broadly described, the present invention provides a method for managing and displaying a representative severity of a network element in a simple network management protocol (SNMP) manager, the method comprising: receiving a packet data unit of a simple network management protocol (SNMP) trap from a network element, the network element to be managed in a simple network management protocol (SNMP) manager; fetching first data to determine a significance of the simple network management protocol (SNMP) trap; determining the significance of the simple network management protocol (SNMP) trap in dependence upon the fetched first data; when the determined significance satisfies a first predetermined criteria, deleting stored alarm input values; when the determined significance does not satisfy the first predetermined criteria, storing a new alarm input value and providing notification of the new alarm input value; determining whether there has been a search for a network element symbol corresponding to the network element; when there has not been a search for the network element symbol, searching for the network element symbol; receiving notification that a representative significance may be changed and receiving a new trap; obtaining a representative significance of the network element in dependence upon the received notification and the received trap; converting the representative significance into a value to be displayed; and displaying the value as a value representative of a severity of a condition of the network element.

To achieve these and other objects in accordance with the principles of the present invention, as embodied and broadly described, the present invention provides, in a system for managing and displaying a representative severity of a network element of a simple network management protocol (SNMP) manager, a method comprising: generating simple network management protocol (SNMP) trap information from a network element, the network element being controlled on a network map by a simple network management protocol (SNMP) manager; analyzing the generated trap information and determining a significance of the generated trap information; and in dependence upon said analyzing and the determined significance, providing first severity information corresponding to a severity of a condition of the network element.

To achieve these and other objects in accordance with the principles of the present invention, as embodied and broadly described, the present invention provides a computer-readable medium having a set of computer-executable instructions for performing a method for managing and displaying a representative severity of a network element in a simple network management protocol (SNMP) manager, the set of instructions comprising one or more instructions for: receiving a packet data unit of a simple network management protocol (SNMP) trap from a network element, the network element to be managed in a simple network management protocol (SNMP) manager; fetching first data to determine a significance of the simple network management protocol (SNMP) trap; determining the significance of the simple network management protocol (SNMP) trap in dependence upon the fetched first data; when the determined significance satisfies a first predetermined criteria, deleting stored alarm input values; when the determined significance does not satisfy the first predetermined criteria, storing a new alarm input value and providing notification of the new alarm input value; determining whether there has been a search for a network element symbol corresponding to the network element; when there has not been a search for the network element symbol, searching for the network element symbol; receiving notification that a representative significance may be changed and receiving a new trap; obtaining a representative significance of the network element in dependence upon the received notification and the received trap; converting the representative significance into a value to be displayed; and displaying the value as a value representative of a severity of a condition of the network element.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a view illustrating a relationship between a manager and agents in the simple network management protocol (SNMP);

FIG. 2 is a view illustrating a message format of the simple network management protocol (SNMP);

FIG. 3 is a flow chart illustrating a method for managing and displaying a representative severity of a network element in the simple network management protocol (SNMP), in accordance with the principles of the present invention;

FIG. 4 is a software block diagram, in accordance with the principles of the present invention; and

FIG. 5 is a diagram showing an apparatus that can perform at least one of the steps of FIG. 3, in accordance with the principles of the present invention.

### DETAILED DESCRIPTION OF THE PREFERRED EMBODIMENTS

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear. Also, the terms used in the following description are terms defined taking into consideration the functions obtained in accordance with the present invention. The definitions of these terms should be determined based on the whole content of this specification because it may be changed in accordance with the option of a user or chip designer or a usual practice.

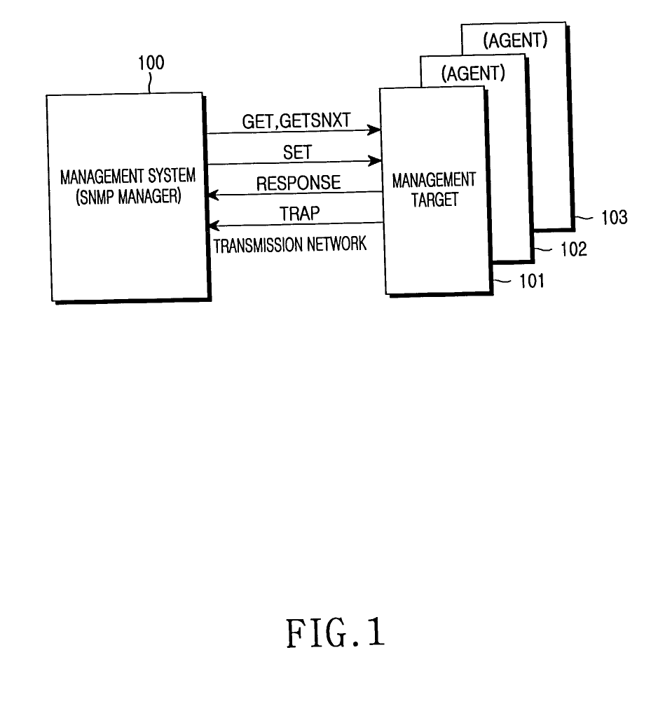

FIG. 1 is a view illustrating a relationship between a manager and agents in the simple network management protocol (SNMP). Generally, in a system adopting the simple network management protocol (SNMP), a management unit is called a manager 100, and management objects are called agents 101 through 103. A management information transmission network which connects the manager 100 and the agents 101 through 103 with each other is based on the transmission control protocol/Internet protocol (TCP/IP) scheme.

Communication using the simple network management protocol (SNMP) is implemented between the manager 100 and the agents 101 through 103 by utilizing instructions such as management information search, management information continuous search, management information set, notification of exceptive operation, and the like, on the basis of a management information base. Further, the simple network management protocol (SNMP) serves as a protocol for enabling management information base exchange between the manager 100 and the agents 101 through 103 and allows a router to be externally managed rather than by console equipment.

A router management system adopting the simple network management protocol (SNMP) provides interface information for displaying a status of each router in the form of the management information base (MIB). The simple network management protocol (SNMP) has a function of a packet data unit (PDU).

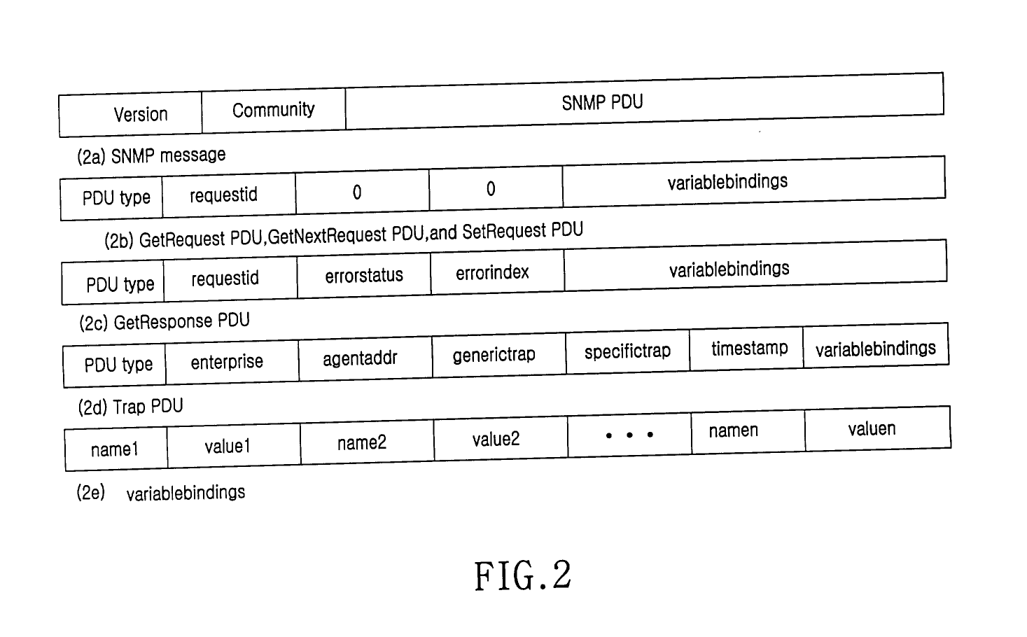

Similarly to the above-described instructions, the SNMP has instructions such as GetResponse for instructing the manager 100 to send management information to the agents 101 through 103, GetNextResponse for continuously fetching information of different management items from the same agent, Response for enabling an agent to respond to the packet data unit (PDU), and Trap (traffic measurement output) to be transmitted as the packet data unit (PDU) to the manager 100 upon occurrence of urgency like failure. These instructions can be readily understood from SNMP message formats of FIG. 2. FIG. 2 is a view illustrating a message format of the simple network management protocol (SNMP). Since these instructions are described in “SNMP1˜3, RMON1˜2” compiled by William Stalling, Addison Wesley, 1996, pages 173˜190, further detailed description thereof shall be omitted herein.

As a result, the manager 100 receives, from the packet data unit (PDU) of the simple network management protocol (SNMP) trap, a unique factor capable of determining a significance, so that a significance of a network element can be reflected with respect to the received SNMP trap. Related features are described in Korean Patent Laid-open Publication No. 10-2001-27156, or in diverse technical publications (for example, “PC TCP/IP illustrated by drawings” compiled by Gi Kwan Kim, Kyobo Book Centre) explaining a “PC TCP/IP”.

Hewlett-Packard OpenView Network Node Manager (HP OV NNM) of Hewlett-Packard Company, U.S.A., serves as a simple network management protocol (SNMP) manager distributed throughout the world, and has been well recognized in terms of performance and operational stability. This system provides various SNMP functions. Also, network maps of the various SNMPs provide corresponding symbols with respect to all network elements supporting the SNMPs, depending upon an IP address within a network environment. A network node manager (NNM) is configured to grasp a severity of the corresponding network element through an Internet control message protocol (ICMP) which is used to report an error of Internet protocol (IP) communication or confirm communication performance. In the case that the network element is not operated, by changing, on the network map, a symbol of the corresponding network element into a single color (red), a user can perceive a severity of the network element. A sub network means all networks detected in Hewlett-Packard OpenView Network Node Manager (HP OV NNM). The sub network is a general network, Internet protocol network.

However, the above-described art suffers from defects in that the network is managed only using information regarding whether or not the network element survives. In this connection, it is the norm that a symbol of a network element generally has a significance of Critical, Major or Warning, depending upon a severity of the network element, and therefore, a severity of the symbol on the network map must be changed depending upon a significance. Nevertheless, because the above-described network map cannot properly reflect these various urgency severities and is configured to be incapable of developing a severity in accordance with each significance, it is impossible to satisfy the user.

In other words, in the above-described art, since it is impossible to grasp severities of the network on the network map and it is only possible to know whether or not the network element survives, a representative severity cannot be obtained depending upon a significance of each severity. In addition, even in the case of employing an API (application programming interface) provided in the network map, in order to implement a processing task for a peculiar simple network management protocol (SNMP) trap provided for each network element, a separate function must be provided for each network element.

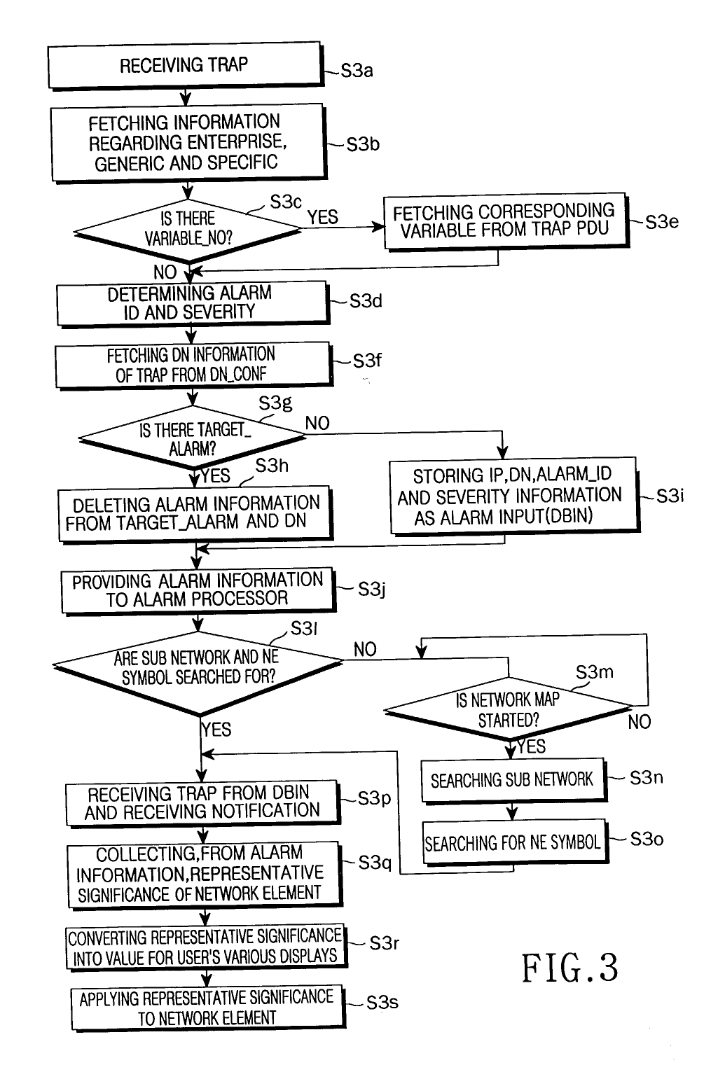

FIG. 3 is a flow chart illustrating a method for managing and displaying a representative severity of a network element in the simple network management protocol (SNMP), in accordance with the principles of the present invention. A trap is an unsolicited notification which is an alarm generated by an agent and sent to management information server (management system).

The method in accordance with the principles of the present invention comprises the following nine steps. There is a first step of generating simple network management protocol (SNMP) trap information (an SNMP trap) by a network element, receiving a packet data unit (PDU) of the simple network management protocol (SNMP) trap from the network element in the SNMP manager, and fetching factors, including Enterprise, Generic and Specific, capable of determining a significance. There is a second step of detecting whether or not a value illustrating a number of a variable (variable_no) exists in the trap packet data unit (PDU) fetched at the first step, directly determining an alarm ID (identifier) and a severity when the value is detected to exist, and fetching the value of the corresponding variable from the trap packet data unit (PDU) and thereafter determining an alarm identifier (ID) and a severity when the value is detected to not exist.

There is a third step of fetching distinguish name (dn) information of the trap from the alarm identifier (ID) and the severity determined at the second step and from a distinguish name (dn) configuration (dn_conf). There is a fourth step of confirming whether a target alarm (target_alarm) exists or not based on the distinguish name (dn) information fetched at the third step, and storing Internet protocol (IP), distinguish name (dn), alarm_id and severity information as alarm information when the target alarm does not exist. There is a fifth step of deleting alarm information from target alarm information and distinguish name (dn) when the target alarm does exist. There is a sixth step of notifying the newly stored value as an alarm input value (dbin) and deletion of alarm information, obtained and implemented at the fourth and fifth steps, respectively, and confirming whether or not a sub network and a network element (NE) symbol are searched. A sub network is a general network, Internet protocol network.

There is a seventh step of receiving the trap and a notification value from the alarm input value when the sub network and network element (NE) symbol are searched at the sixth step, and, when the sub network and network element (NE) symbol are not searched at the sixth step, confirming whether or not a network map is started, searching the sub network and network element (NE) symbol with the network map started, and then receiving the trap and a notification value from the alarm input value. There is an eighth step of obtaining a representative significance of the network element and converting the representative significance into a value for allowing various displays by users when the trap and the notification value are received from the alarm input value (dbin) at the seventh step. There is a ninth step of processing the representative significance with respect to the network element, using the value converted at the eighth step.

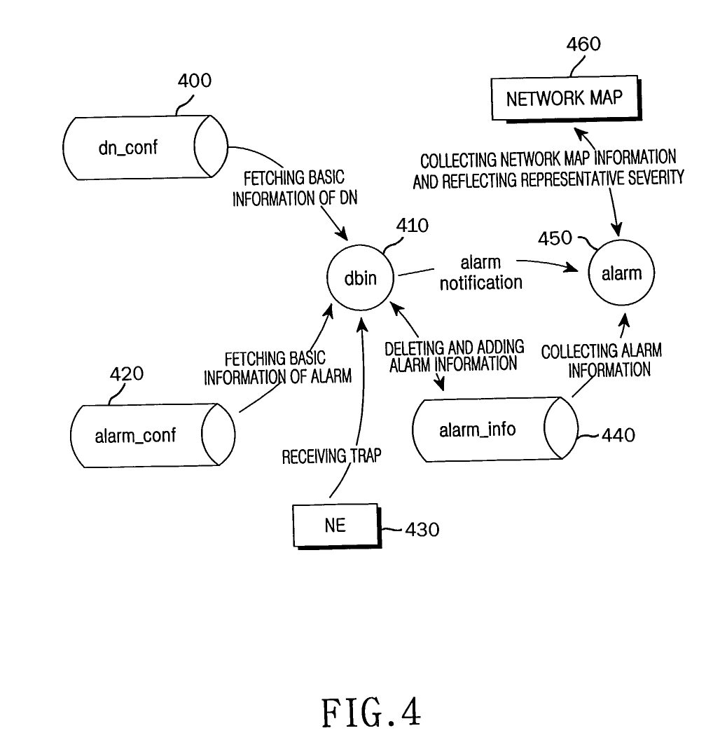

Accordingly, in order to embody the present invention, data must be first configured in a manner such that representative severities can be applied to all network elements supporting a simple network management protocol (SNMP) 100. FIG. 4 is a software block diagram, in accordance with the principles of the present invention.

Here, as can be readily seen from FIG. 4, in order to allow a unique significance to be determined with respect to a trap of the simple network management protocol (SNMP) 100, the data configuration comprises an alarm_conf structure 420, a dn_conf structure 400 providing information for enabling a dn (distinguish name) to be fetched from the SNMP trap, and an alarm_info structure 440 for actually administrating trap information. These data structures will be set forth in an XML (extensible markup language) DTD (data type definition). FIG. 4 also shows alarm 450, network map 460, dbin 410, and network element (NE) 430.

In order to determine a significance for each simple network management protocol (SNMP) trap in the second step, as shown at (2b) of FIG. 2, a unique factor capable of determining a significance of a network element with respect to the SNMP trap is fetched from a packet data unit (PDU) of the SNMP trap. Since it is the norm that one trap represents one significance, it is sufficient to determine significance using the following alarm conf structure. In other words, only with information regarding an enterprise, a generic type and a specific type of the trap packet data unit (PDU), is it possible to secure uniqueness of a significance. Namely, as shown at (2d) of FIG. 2, the trap packet data unit (PDU) has SNMP formats of the enterprise, generic type and specific type. A structure of the trap packet data unit (PDU) is expressed as follows.

<!DOCTYPE alarm_conf[

<!ELEMENT alarm_conf(alarm_id, severity_value, enterprise, generic, specific)>

<!ELEMENT alarm_id (#PCDATA)>

<!ELEMENT severity_value (#PCDATA)>

<!ELEMENT enterprise (#PCDATA)>

<!ELEMENT generic (#PCDATA)>

<!ELEMENT specific (#PCDATA)>

]>

Here, the alarm_id is a representative trap ID (identifier) capable of possessing a unique severity, and the enterprise, generic and specific are structural information of the simple network management protocol (SNMP) packet data unit (PDU).

While it is the norm that an alarm identifier (ID) or a significance can be determined with respect to one trap in the trap packet data unit (PDU) only using the above-described information, in a peculiar case there may be a problem in distinguishing a unique significance. That is to say, although alarm information is received in one trap, as exemplified at (2d) of FIG. 2, when analyzing a variable binding in the trap, a significance of the trap can vary depending upon a value of the variable binding.

For example, if the value of the variable binding is 1, information can be configured as urgency, and if the value of the variable binding is 0, information can be configured as urgency release. For example, on the assumption that an abnormality is raised in an element port, the urgency can be classified into a critical, major, minor, and normal depending upon an extent of the abnormality of the port. And, a corresponding urgency information can be defined as values of 1, 2, 3, 0, etc. according to realization of an agent. (It is a matter of course that these are values determined arbitrarily by a realizer.) And, the relevant content is defined as a value of variable binding in the trap, and then transmitted to management system. If so, a corresponding trap can be classified into the four alarms depending upon the assumed value. Therefore, in the above structures, information must be provided regarding with respect to which value of what variable binding a significance varies. A structure according to this may be given as follows.

<!DOCTYPE alarm_conf[

<!ELEMENT alarm_conf(alarm_id, severity_value, enterprise, generic, specific, variable_no?, variable_value?)>

<!ELEMENT alarm_id (#PCDATA)>

<!ELEMENT severity_value (#PCDATA)>

<!ELEMENT enterprise (#PCDATA)>

<!ELEMENT generic (#PCDATA)>

<!ELEMENT specific (#PCDATA)>

<!ELEMENT variable_no (#PCDATA)>

<!ELEMENT variable_value (#PCDATA)>

]>

Here, as shown at (2e) of FIG. 2, the number of variables (variable_no) indicates information regarding which variable is to be searched among variable bindings of the trap, and a value of the corresponding variable is referred to as a “variable_value”. Since the two information, that is, the variable_no and variable_value can or cannot exist, occurrence indicators are given as ‘?’.

Meanwhile, in order to find out a significance release target in the fifth step, there is an occasion when a release trap is received with respect to a network element in which a trap actually occurs and which has a significance of a constant state, and thereby existing severity information maintained with respect to the network element must be released. “Release target” means a location (equipment), namely, an object to be released. “Release trap” means a signal for informing the result that a defect is solved after raising an alarm. “Significance” can be critical, major, minor, or warning, for example. In this case, it is necessary to find out to which one among the existing alarm conditions the release information of the release trap belongs. “Release information” means a signal for releasing the existing state. For example, on the assumption that A alarm having a critical severity and B alarm having major severity are raised in the element, the representative alarm of a corresponding element becomes critical by having the highest severity. Although, the representative alarm is critical, the critical severity and major severity should be maintained with respect to the relevant element. In this status, if B′ alarm exists and B′ alarm is a release alarm of B alarm, B alarm maintained in the corresponding element should be released, in case that B′ alarm is received. In this regard, the following elements are added to the alarm_conf structure.

<!DOCTYPE alarm_conf[

<!ELEMENT alarm_conf(alarm_id, severity value, enterprise, generic, specific, variable_no?, variable_value?, target_alarm*)>

<!ELEMENT alarm_id (#PCDATA)>

<!ELEMENT severity_value (#PCDATA)>

<!ELEMENT enterprise (#PCDATA)>

<!ELEMENT generic (#PCDATA)>

<!ELEMENT specific (#PCDATA)>

<!ELEMENT variable_no (#PCDATA)>

<!ELEMENT variable_value (#PCDATA)>

<!ELEMENT target_alarm (#PCDATA)>

]>

Here, the target_alarm indicates an identifier (ID) of a target alarm to be released in the case of the release trap. Usually, a target_alarm may or may not exist. Also, since there arise occasions when several target alarms are to be released, occurrence indicators are given as ‘*’.

A structure for administrating traps actually received in unison to thereby administrate actual alarm information received as in the fourth step is simple. This structure comprises a network element identifier (NE ID) (an Internet protocol address is generally used) capable of distinguishing a network element, a distinguish name (dn) for finding out in which part of the network element corresponding information is generated, and an alarm_id and a severity obtained from the alarm_conf.

<!DOCTYPE alarm_info [

<!ELEMENT alarm_info(ip, dn, alarm_id, severity_value)>

<!ELEMENT ip (#PCDATA)>

<!ELEMENT dn (#PCDATA)>

<!ELEMENT alarm_id (#PCDATA)>

<!ELEMENT severity_value (#PCDATA)>

]>

In the alarm_info for administrating the distinguish name (dn), in order to configure the distinguish name (dn), information is needed regarding which variable binding in the trap packet data unit (PDU) is to be used. To this end, the following structure is needed.

[!DOCTYPE dn_conf[

<!ELEMENT dn_conf(dn, varible_no*, variable_value*)>

<!ELEMENT dn (#PCDATA)>

<!ELEMENT variable_no (#PCDATA)>

<!ELEMENT variable_value (#PCDATA)>

]>

Here, the variable number (variable_no) serves as information regarding information of which variable in the trap packet data unit (PDU) is to be fetched, and a value of the corresponding variable is referred to as a “variable_value”. Since the two information items, that is, the variable_no and variable_value may or may not exist, occurrence indicators are given as

Accordingly, hereafter, a concrete embodiment of the present invention will be described in detail with reference to FIGS. 1 through 4.

1. Operations of storing alarm information for determining a significance of a network element

With reference to FIG. 3, at step S3a, a simple network management protocol (SNMP) trap is received from a network element to be managed or controlled. At step S3b, the received SNMP trap is analyzed. At step S3b, information regarding an enterprise object identifier (OID), a generic trap type and a specific trap type is fetched from a packet data unit (PDU) of the received trap in the format of (2d) given in FIG. 2.

At step S3c, a determination is made to see whether a value of the variable_no factor exists or not. If a value of the variable_no factor does exist then step S3d is performed directly after step S3c. However, if a value of the variable_no factor does not exist then step S3e is performed directly after step S3c.

At step S3d, an alarm_id and a significance of the currently received trap are determined from an alarm_conf on the basis of the information fetched at step S3b. To this end, before step S3d, a value of a variable_no factor is checked at step S3c since the corresponding trap may have various significances depending upon contents of a variable binding in (2d) of FIG. 2.

At step S3d, a variable of an order corresponding to the given value is analyzed from a trap packet data unit (PDU), and an alarm_id and a severity of the currently received trap are determined from the alarm_conf using the value. However, if there is no variable_no indicating variables at step S3c, then step S3e is performed before step S3d. At step S3e, the value of a corresponding variable is fetched again from the packet data unit (PDU), and the program then proceeds to step S3d. A significance, in step S3d, is a significance of an alarm received and then analyzed at this time. The alarm received from a trap has a significance regardless of critical, major, minor, or release. A representative significance is retained with the significance of various levels in various kinds of alarms. The highest significance among them is the representative significance.

At step S3f, information of variable bindings for determining a distinguish name (dn) is collected from a dn_conf, and the distinguish name (dn) is fetched by reading information from the trap packet data unit (PDU). At step S3g, a determination is made as to whether a target_alarm exists or not based on the value detected at step S3f. If the result of step S3g is “yes, there is a target_alarm” then step S3h is performed. If the result of step S3g is “no, there is not a target_alarm” then step S3i is performed in lieu of step S3h.

If a determined significance refers to a significance related with release, in order to find, from the existing alarm information, an alarm_id as a target to be released, a target alarm is obtained again from the alarm_conf. In other words, when a determined significance refers to a significance related with release, then a target_alarm is obtained again from the alarm_conf in order to find an alarm_id as a target to be released. This alarm id is found from the existing alarm information.

When it is checked at step S3g implemented on the basis of the distinguish name (dn) information collected at step S3f that a target alarm does exist then step S3h is performed. At step S3h, alarm information stored in an alarm_info configuration is deleted. However, if there is no target_alarm, since a determined significance does not refer to release then step S3i is performed in lieu of step S3h. At step S3i, Internet protocol (IP) information is collected from the trap packet data unit (PDU), and new alarm information (dnin) is stored in the alarm_info using the alarm_id, the severity and the distinguish name (dn) obtained at the above-described steps.

Then, at step S3j, all alarm information obtained through steps S3i through S3h is stored and is provided to an alarm process which is in a stand-by state to display a representative significance on a network map.

2. Operations of reflecting a representative significance of a network element symbol from alarm information

With continued reference to FIG. 3, the alarm process must perform a preparatory task for once reflecting a representative significance on the network map, irrespective of interlock with an alarm input (dbin) process. First of all, at step S31, a determination is made as to whether or not a sub network and a network element (NE) symbol are searched for. If the subnetwork and network element are not searched for, then steps S3m, S3n, S3o are performed next. However, if the subnetwork and network element are searched for, then step S3p is performed next.

If the subnetwork and network element are not searched for, then, at step S3m, a confirmation is made as to whether or not the network map is started. If it is confirmed that the network map is started, a sub network is searched for a symbol of an element intended to be managed at step S3n, and then a search is conducted to find a network element (NE) symbol at step S3o. In other words, if the network map is started, a sub network provided to a current user is searched, and a corresponding network element (NE) symbol is searched for based on the sub network. Step S3p is performed after step S3o. If Open View Window (OVW) is first operated, step S3o searches sub network, all networks, detected in Hewlett-Packard OpenView Network Node Manager (HP OV NNM) Open View Window (OVW) that is provided to the current user at step S3o. “Open View Window” (OVW) is a network map in which symbols displayed with respect to all equipment supporting simple network management protocol (SNMP). The Hewlett-Packard OpenView Network Node Manager (HP OV NNM) Open View Window (OVW) provides various functions as a simple network management protocol (SNMP) manager. One of the various functions relates to Open View Window (OVW), network map in the present invention which is to provide OVW with information of various states.

If it is judged at step S31 that a sub network and a network element (NE) symbol were searched, then step S3p is performed. At step S3p, a new alarm is issued from the dbin process, and a message notifying that the representative significance may be changed is received. At step S3p, if new alarm data from the network in dbin processor is obtained, the new alarm data is processed by an ovalarm processor, and is presented as a symbol with respect to the corresponding equipment searched on Open View Window at steps S3n and S3o. “Ovalarm processor” is a processor that collects/processes an alarm information for providing with Open View (OV). Thereafter, at step S3q, based on the received alarm information, a representative significance for the corresponding network element is fetched and collected from the alarm_info. At step S3r, the representative significance is converted into a value for a user's various displays. Then, at step S3s, the representative significance is outputted using a color matching the corresponding representative significance or various other methods, and the current representative significance of the network element is changed and displayed.

As described above, in the present invention, due to a new configuration and an alarm input (dbin) process, it is possible to manage alarm information for all network elements supporting the simple network management protocol (SNMP). Also, since various significances and a representative significance of a network element can be represented on a network map, corresponding information can be provided in connection with a process, whereby functions of more powerful extended messaging system (EMS) and network management system (NMS) can be provided to a user.

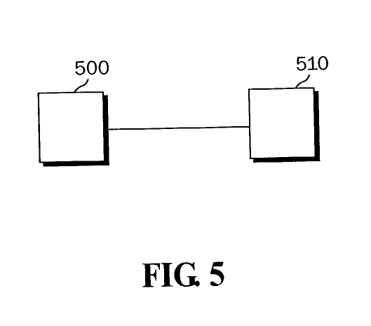

FIG. 5 is a diagram showing an apparatus that can perform at least one of the steps of FIG. 3, in accordance with the principles of the present invention. In an embodiment, at least one of the above-described steps of the present invention can correspond to instructions stored in one or more memory units, similar to the memory unit 500 shown in FIG. 5. Instructions stored in the memory unit 500 can be executed or performed by one or more computers, similar to the computer 510 shown in FIG. 5. The computer 510 is in communication with the memory unit 500. The memory unit 500 is a computer-readable medium. The memory unit 500 could be any kind of computer memory such as floppy disks, conventional hard disks, removable hard disks, compact discs (CDs), digital versatile discs (DVDs), flash read only memory (flash ROM), nonvolatile read only memory, and random access memory (RAM), for example.

A software implementation of the above-described embodiment may comprise a series of computer instructions either fixed on a tangible medium, such as a computer readable media, for example a compact disc or a fixed disk, or transmissible to a computer system via a modem or other interface device over a medium. The medium can be either a tangible medium, including, but not limited to, optical or analog communications lines, or may be implemented with wireless techniques, including but not limited to microwave, infrared or other transmission techniques. The medium may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, for example, shrink wrapped software, pre-loaded with a computer system, for example, on system read only memory (ROM) or fixed disk, or distributed from a server or electronic bulletin board over a network, for example, the Internet or World Wide Web.

The foregoing paragraphs describe the details of a method for managing a network element, and more particularly, describe the details of a system and a method which analyze and administrate simple network management protocol (SNMP) trap information generated from a network element managed on a network map by an SNMP manager, so that severity information with respect to a network element symbol on the network map is provided by various means and a representative severity of the corresponding element is provided.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A method for managing and displaying a representative severity of a network element in a simple network management protocol (SNMP) manager, the method comprising:
receiving a packet data unit of a simple network management protocol (SNMP) trap from a network element, the network element to be managed in a simple network management protocol (SNMP) manager;
fetching first data to determine a significance of the simple network management protocol (SNMP) trap;
determining the significance of the simple network management protocol (SNMP) trap in dependence upon the fetched first data;
when the determined significance satisfies a first predetermined criteria, deleting stored alarm input values;
when the determined significance does not satisfy the first predetermined criteria, storing a new alarm input value and providing notification of the new alarm input value;
determining whether there has been a search for a network element symbol corresponding to the network element;
when there has not been a search for the network element symbol, searching for the network element symbol;
receiving notification that a representative significance may be changed and receiving a new trap;
obtaining a representative significance of the network element in dependence upon the received notification and the received trap;
converting the representative significance into a value to be displayed; and
displaying the value as a value representative of a severity of a condition of the network element.

2. The method of claim 1, the determined significance satisfying the first predetermined criteria when the determined significance refers to a significance related with release, the determined significance not satisfying the first predetermined criteria when the determined significance does not refer to a significance related with release.

3. The method of claim 1, said searching for the network element symbol being performed when the network map is started.

4. The method of claim 3, said determining whether there has been a search for a network element symbol further comprising determining whether a sub network has been searched.

5. The method of claim 4, said searching for the network element symbol further comprising searching the sub network when the network map is started.

6. The method of claim 1, said determining whether there has been a search for a network element symbol further comprising determining whether a sub network has been searched.

7. The method of claim 6, said searching for the network element symbol further comprising searching the sub network when the network map is started.

8. The method of claim 1, said deleting of the stored alarm input values further comprising finding a target to be released.

9. The method of claim 1, further comprising:
before said determining of the significance of the simple network management protocol (SNMP) trap, detecting whether there is a value for a variable_no of the simple network management protocol (SNMP) trap; and
when said detecting detects no value for the variable_no, fetching second data from the simple network management protocol (SNMP) trap.

10. The method of claim 9, when said detecting detects no value for the variable_no, said determining of the significance of the simple network management protocol (SNMP) trap being in dependence upon the fetched first data and the fetched second data.

11. In a system for managing and displaying a representative severity of a network element of a simple network management protocol (SNMP) manager, a method comprising:
generating simple network management protocol (SNMP) trap information from a network element, the network element being controlled on a network map by a simple network management protocol (SNMP) manager;
analyzing the generated trap information and determining a significance of the generated trap information; and
in dependence upon said analyzing and the determined significance, providing first severity information corresponding to a severity of a condition of the network element.

12. The method of claim 11, further comprising providing second severity information of a network element symbol on the network map, the network element symbol corresponding to the network element.

13. The method of claim 12, further comprising displaying data corresponding to the first severity information to a user.

14. The method of claim 11, further comprising displaying data corresponding to the first severity information to a user.

15. A computer-readable medium having a set of computer-executable instructions for performing a method for managing and displaying a representative severity of a network element in a simple network management protocol (SNMP) manager, the set of instructions comprising one or more instructions for:
receiving a packet data unit of a simple network management protocol (SNMP) trap from a network element, the network element to be managed in a simple network management protocol (SNMP) manager;
fetching first data to determine a significance of the simple network management protocol (SNMP) trap;
determining the significance of the simple network management protocol (SNMP) trap in dependence upon the fetched first data;
when the determined significance satisfies a first predetermined criteria, deleting stored alarm input values;
when the determined significance does not satisfy the first predetermined criteria, storing a new alarm input value and providing notification of the new alarm input value;
determining whether there has been a search for a network element symbol corresponding to the network element;
when there has not been a search for the network element symbol, searching for the network element symbol;
receiving notification that a representative significance may be changed and receiving a new trap;
obtaining a representative significance of the network element in dependence upon the received notification and the received trap;
converting the representative significance into a value to be displayed; and
displaying the value as a value representative of a severity of a condition of the network element.

16. The computer-readable medium of claim 15, the determined significance satisfying the first predetermined criteria when the determined significance refers to a significance related with release, the determined significance not satisfying the first predetermined criteria when the determined significance does not refer to a significance related with release.

17. The computer-readable medium of claim 16, said searching for the network element symbol being performed when the network map is started.

18. The computer-readable medium of claim 17, said determining whether there has been a search for a network element symbol further comprising determining whether a sub network has been searched.

19. The computer-readable medium of claim 18, said searching for the network element symbol further comprising searching the sub network when the network map is started.

20. The computer-readable medium of claim 19, said deleting of the stored alarm input values further comprising finding a target to be released.

21. The computer-readable medium of claim 20, the set of instructions further comprising one or more instructions for:
before said determining of the significance of the simple network management protocol (SNMP) trap, detecting whether there is a value for a variable_no of the simple network management protocol (SNMP) trap; and
when said detecting detects no value for the variable no, fetching second data from the simple network management protocol (SNMP) trap.

22. The computer-readable medium of claim 21, when said detecting detects no value for the variable_no, said determining of the significance of the simple network management protocol (SNMP) trap being in dependence upon the fetched first data and the fetched second data.
